(19) United States
(12) Patent Application Publication
(10) Pub. No.: US 2014/0111644 A1
(43) Pub. Date: Apr. 24, 2014

(54) VEHICLE ASSEMBLY WITH DISPLAY AND CORRECTIVE LENS

(71) Applicant: GM GLOBAL TECHNOLOGY OPERATIONS LLC, Detroit, MI (US)

(72) Inventor: JOSEPH P. FANNON, WASHINGTON, MI (US)

(73) Assignee: GM GLOBAL TECHNOLOGY OPERATIONS LLC, Detroit, MI (US)

(21) Appl. No.: 13/659,611

(22) Filed: Oct. 24, 2012

(51) Int. Cl. H04N 7/18; G02B 27/02

(52) U.S. Cl. 348/148; 359/810

(57) ABSTRACT

Assemblies are provided for vehicles having an occupant seat. The assemblies comprise a display and a corrective lens. The corrective lens is disposed between the display and the occupant seat.

### TECHNICAL FIELD

The technical field generally relates to the field of vehicles and, more specifically, to a vehicle assembly with a display and a corrective lens.

### BACKGROUND

Many vehicles include a display viewed by the driver, such as a video screen in a rear view mirror assembly that is coupled to a rear view camera for the vehicle. However, such a display may not always be easily viewed in an optimal matter. For example, if a driver of the vehicle is far-sighted or is wearing eyeglasses or contact lenses to correct a near-sighted optical condition, the driver's view of the display may not be as clear as desired.

Accordingly, it is desirable to provide improved assemblies for vehicles that provide for improved viewing of such displays, such as those coupled to a back-up camera of the vehicle, for example for people that may be nearsighted or wearing eyeglasses or contact lenses to correct a far sighted optical condition.

### SUMMARY

In accordance with an exemplary embodiment, an assembly for a vehicle having an occupant seat is provided. The assembly comprises a display and a corrective lens. The corrective lens is disposed between the display and the occupant seat.

In accordance with another exemplary embodiment, a rear view mirror assembly for a vehicle having a front seat is provided. The rear view mirror assembly comprises a housing, a video screen and a mirror. The video screen is disposed within the housing, and is coupled to a back-up camera for the vehicle. The mirror is disposed within the housing between the video screen and the front seat. The corrective lens is disposed between the video screen and the front seat. The corrective lens is movable between a first position, in which the corrective lens covers the video screen, and a second position, in which the corrective lens does not cover the video screen.

In accordance with a further exemplary embodiment, a vehicle is provided. The vehicle comprises a body, an occupant seat, and an assembly. The body forms an interior of the vehicle. The occupant seat is disposed within the interior. The assembly comprises a display and a corrective lens. The corrective lens is disposed between the display and the occupant seat.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes an assembly having a display and a corrective lens, in accordance with an exemplary embodiment;

FIGS. 2-5 include schematic, exploded view, and sectional diagrams of the assembly of FIG. 1 in accordance with a first exemplary embodiment, in which the assembly comprises a rear view mirror assembly in which the corrective lens is slidably movable into and out of a housing of the assembly;

FIGS. 6-8 include schematic and sectional schematic diagrams of the assembly of FIG. 1 in accordance with a second exemplary embodiment, in which the assembly comprises a rear view mirror assembly in which the corrective lens is rotatably movable between a first position and a second position;

FIGS. 9 and 10 include schematic and sectional schematic diagrams of the assembly of FIG. 1 in accordance with an alternate exemplary embodiment, in which the assembly comprises a gauge for an instrument panel of the vehicle; and

FIGS. 11 and 12 include schematic and sectional schematic diagrams of the assembly of FIG. 1 in accordance with another alternate exemplary embodiment, in which the assembly comprises an infotainment of the vehicle that provides information or entertainment to occupants of the vehicle.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

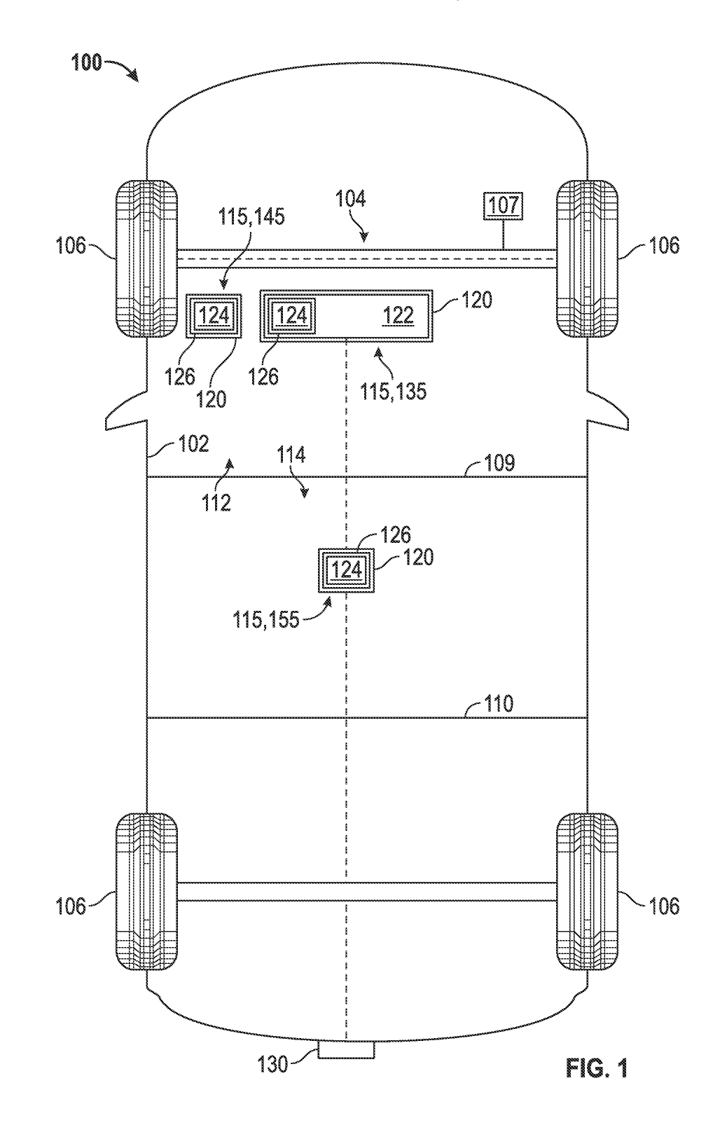

FIG. 1 illustrates a vehicle 100, according to an exemplary embodiment. As described in greater detail further below, the vehicle 100 includes an assembly 115 used by occupants of the vehicle 100 for viewing a display 124. In one such embodiment, depicted in FIG. 1, the assembly 115 comprises a rear view mirror assembly 135 of the vehicle 100, and the display 124 comprises a video screen of the rear view mirror assembly 135. In another embodiment, the assembly 115 comprises an instrument panel 145 of the vehicle 100, and the display 124 is part of a gauge for the instrument panel 145. In yet another embodiment, the assembly 115 comprises an infotainment unit 155 of the vehicle 100 (i.e., a unit that provides information and/or entertainment for vehicle occupants, preferably occupants of the rear rows 110 of the vehicle 100), and the display 124 is part of a video screen for the infotainment unit 155. The vehicle 100 preferably comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments.

The vehicle 100 includes a body 102 that is arranged on a chassis 104. The body 102 substantially encloses other components of the vehicle 100. The body 102 and the chassis 104 may jointly form a frame. The vehicle 100 also includes a plurality of wheels 106. The wheels 106 are each rotationally coupled to the chassis 104 near a respective corner of the body 102 to facilitate movement of the vehicle 100. In a preferred embodiment, the vehicle 100 includes four wheels 106, although this may vary in other embodiments (for example for trucks and certain other vehicles).

The drive system 107 is mounted on the chassis 104, and drives the wheels 106. The drive system 107 preferably comprises a propulsion system. In certain exemplary embodiments, the drive system 107 comprises an internal combustion engine and/or an electric motor/generator, coupled with a transmission thereof. In certain embodiments, the drive system 107 may vary, and/or two or more drive systems 107 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

As depicted in FIG. 1, the vehicle 100 includes a front row 109 of passenger seating (also referred to as front seats) and a rear row 110 of passenger seating (also referred to as rear seats) within an interior of the vehicle 100 enclosed by the body 102. In the depicted embodiment, there is one rear row 110 of passenger seating. However, in certain other embodiments there may be two or more rear rows 110 of passenger seating, or no rear rows 110 in certain embodiments. The front row 109 and rear row(s) 110 may be collectively referred to as occupant seats of the vehicle 100.

With further reference to FIG. 1, a front portion 112 of the vehicle 100 is referred to herein as the region inside the body 102 of the vehicle 100 that is (i) in front of the front row 109 and that is (ii) visible to occupants of the vehicle that are seated in the front row 109 while facing forward. A rear portion 114 of the vehicle 100 is referred to herein as region inside the body 102 of the vehicle 100 that is behind the front row 109.

As depicted in FIG. 1, in certain embodiments the assembly 115 comprises a mirror assembly 135 for the vehicle 100. As depicted, the mirror assembly 135 comprises a rear view mirror assembly 135 disposed in the front portion 112 of the vehicle 100. In certain embodiments, the mirror assembly 135 may comprise one or more side mirrors disposed outside the vehicle 100. In the rear view mirror assembly 135 embodiment of FIG. 1, the assembly 115 includes a housing 120, a mirror 122, a display 124, and a corrective lens 126. In one embodiment, the housing 120 is preferably attached, directly or indirectly, to the front windshield or to the headliner of the vehicle 100.

With respect to the rear view mirror assembly 135 embodiments for the assembly 115, the mirror 122 is disposed at least partially within the housing 120, preferably proximate a front portion of the housing 120 on a side of the housing 120 facing the front seats 109. The mirror 122 preferably comprises a rear view mirror for the vehicle 100. In one embodiment, the mirror 122 comprises a two-way mirror that is partially transparent and partially reflective. In one such embodiment, the mirror 122 comprises a core material (preferably a glass material) and a coating (preferably a silver coating) on one side of the core material.

The display 124 is disposed within the housing 120, preferably proximate a rear portion of the housing 120 on a side of the housing 120 proximate the front windshield (and away from the front seats 109). Accordingly, the display 124 is disposed between the mirror 122 and the windshield. Alternatively stated, the mirror 122 is disposed between the display 124 and the front seats 109. As depicted in FIG. 1, the display 124 covers a portion of the mirror 122, but not the entire mirror 122, so that the mirror 122 and the display 124 can be used simultaneously. Preferably, the display 124 is visible only when the vehicle 100 is in a reverse gear. In the depicted embodiment, the display 124 comprises a video screen that is coupled to a rear view camera 130 of the vehicle 100 (preferably, a rear view camera that is mounted on a rear portion of the vehicle 100 and that provides video images from behind the vehicle, particularly when the vehicle is backing up in reverse). In one exemplary embodiment the display 124 comprises a liquid crystal display (LCD) screen or a light emitting diode (LED) screen.

The corrective lens 126 is disposed between the display 124 and the front seats 109. The corrective lens 126 is approximately the size of the display 124. The corrective lens 126 is movable between a first position, in which the corrective lens 126 covers the display 124, and a second position, in which the corrective lens 126 does not cover the display 124. The corrective lens 126 modifies the focal length of the image from the display 124 such that it corrects for the far sightedness of the vehicle occupant when the corrective lens 126 is in the first position. The corrective lens 126 preferably comprises a convex lens. In one embodiment, the corrective lens 126 is made of a plastic material. In another embodiment, the corrective lens 126 is made of a glass material. The corrective lens 126 and the mirror 122 are both disposed between the display 124 and the front seat 109.

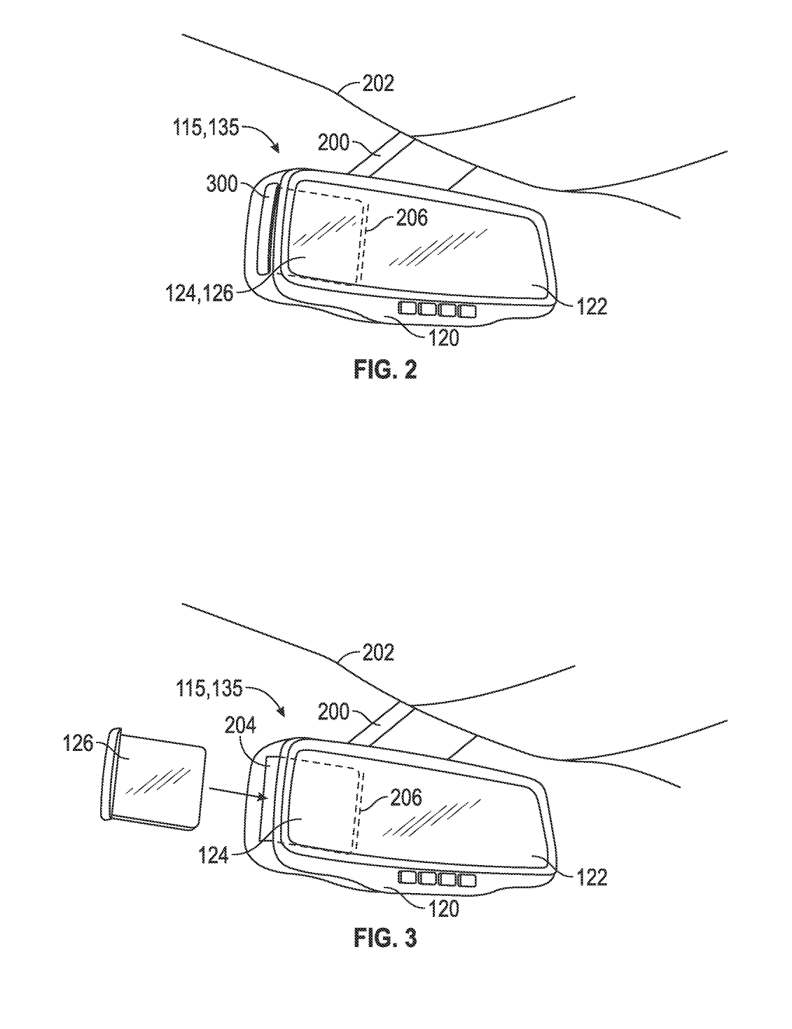

FIGS. 2-5 depict the assembly 115 of FIG. 1 in accordance with a first exemplary embodiment for the rear view mirror assembly 135 embodiments of FIG. 1. In the embodiment of FIGS. 2-5, the assembly 115 comprises a rear view mirror assembly 135 in which the corrective lens 126 is slidably movable into and out of the housing 120. Also as shown in FIGS. 2-5, the housing 120 is connected to the headliner 202 of the vehicle 100 via a base 200 (in certain examples, the housing 120 may instead be connected to a windshield of the vehicle).

As depicted in FIGS. 2-5, the corrective lens 126 is slidable between a first position and a second position. When in the first position (depicted in FIG. 2), the corrective lens 126 covers the display 124, to thereby modify the focal length of the image from the display 124 for viewing by the driver. Also, when in the first position of FIG. 2, the corrective lens 126 is disposed within the housing 120, between the display 124 and the mirror 122. In addition, when in the first position of FIG. 2, the mirror 122 is disposed at least partially within the housing 120 between the display 124 and the front seats 109 (and between the corrective lens 126 and the front seats 109).

Also as shown in FIG. 2, when in the first position, the corrective lens 126 is disposed within the housing 120 against a stop 206 on one side, and is held in place on an opposite side by a cap 300 that may or may not be integral to the corrective lens 126. In one embodiment, the corrective lens 126 snaps into place within the housing 120 while in the first position of FIG. 2. In another embodiment, the cap 300 comprises a latching feature for securing the corrective lens 126 in place while in the first position of FIG. 2.

When in the second position (depicted in FIG. 3), the corrective lens 126 does not cover the display 124. Specifically, when in the second position of FIG. 3, the corrective lens 126 is disposed outside the housing 120, so that the focal length correction is not provided for the display 124.

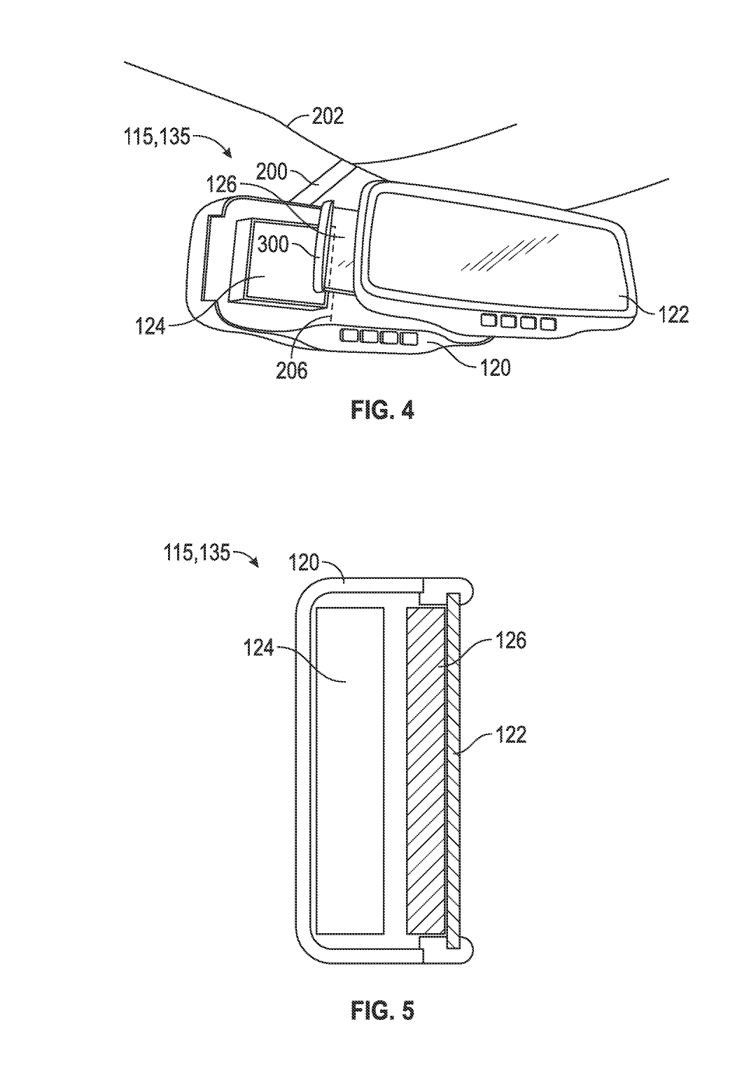

By way of example, the corrective lens 126 may remain in the first position of FIG. 2, within the housing 120 and covering the display 124, when the vehicle 100 is operated by a driver that requires the corrective lens 126 (for example, a driver with a far-sighted condition, or that is wearing eyeglasses to correct a near-sighted condition). By way of further example, the corrective lens 126 may be removed from the housing 120 into the second position of FIG. 3 when the vehicle is operated by a driver that does not require the corrective lens 126. FIGS. 4 and 5 are also provided showing an exploded view and a sectional view, respectively, of the assembly in accordance with the first embodiment of FIGS. 2-5.

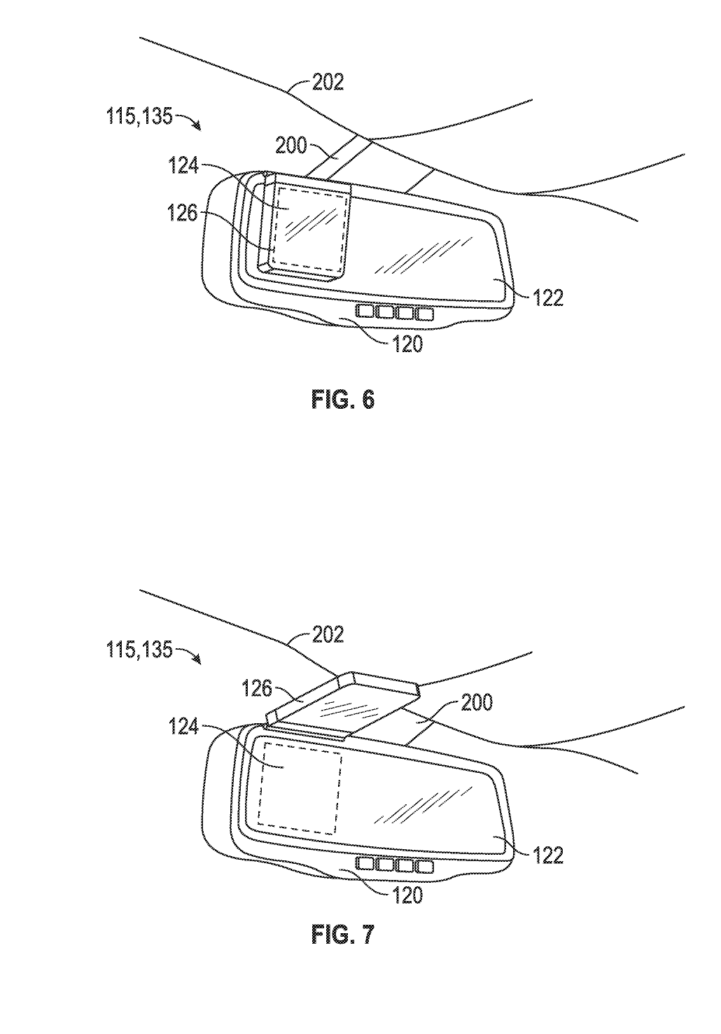

FIGS. 6-8 depict the assembly 115 of FIG. 1 in accordance with a second exemplary embodiment of the rear view mirror assembly 135 embodiments of FIG. 1. In the embodiment of FIGS. 6-8, the assembly 115 comprises a rear view mirror assembly 135 in which the corrective lens 126 is rotatably movable about an axis with respect to the housing 120, the mirror 122, and the display 124. Also as shown in FIGS. 6-8, the housing 120 is connected to the headliner 202 of the vehicle 100 via a base 200 (in some embodiments, the housing 120 may instead be connected to the front windshield of the vehicle).

As depicted in FIGS. 6-8, a top portion of the corrective lens 126 is attached to the housing 120, above the mirror 122, and is rotatable between a first (flip-down) position and a second (flip-up) position. When in the first position (depicted in FIG. 6), the corrective lens 126 covers the display 124, to thereby modify the focal length of the display 124 for the driver. Also when in the first position of FIG. 6, the mirror 122 is disposed against the housing 120, adjacent to the mirror 122. In addition, when in the first position of FIG. 6, the mirror 122 is disposed at least partially within the housing 120 between the display 124 and the front seats 109, and the corrective lens 126 is disposed between the mirror 122 and the front seats 109.

When in the second position (depicted in FIG. 7), the corrective lens 126 does not cover the display 124. Specifically, when in the second position of FIG. 7, the corrective lens 126 is rotated away from the mirror 122 and the display 124, so that focal length correction is not provided for the display 124. In one example, the corrective lens 126 may be substantially perpendicular to the mirror 122 and the display 124 when in the second position of FIG. 7. In another example, the corrective lens 126 may be substantially flush with a roof or headliner of the vehicle 100 when in the second position.

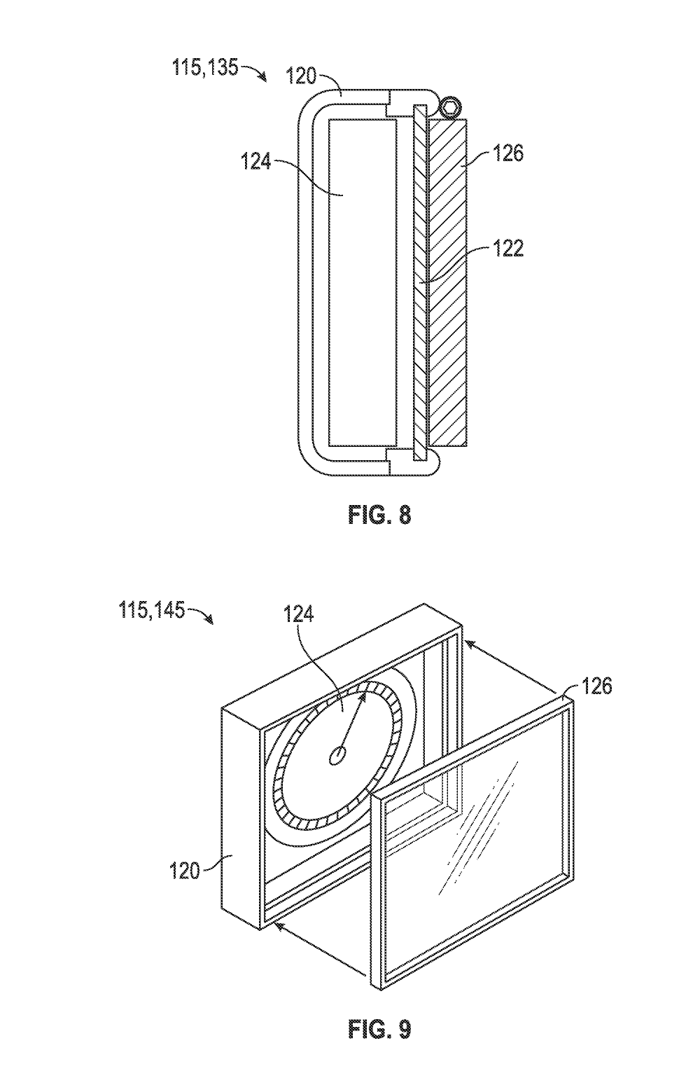

By way of example, the corrective lens 126 may remain in the first position of FIG. 6 when the corrective lens 126 is needed, for example when the vehicle is backing up and the rear view camera 130 of FIG. 1 is needed (for example by a driver with a far-sighted condition, or that is wearing eyeglasses to correct a near-sighted condition). By way of further example, the corrective lens 126 may be rotated into the second position of FIG. 7 when the corrective lens 126 is not required, for example when the rear-view camera 130 is not in use, or when the vehicle 100 is being operated by a driver that does not require the corrective lens 126 at all. FIG. 8 is also provided showing a sectional view of the assembly 115 in accordance with the second embodiment of FIGS. 6-8.

Returning to FIG. 1, and as mentioned above, in an alternate embodiment, the assembly 115 comprises an instrument panel 145 for the vehicle 100. The instrument panel 145 may be located, by way of example, in front of the driver's side of the front row 109 of the vehicle, and/or above the rear view mirror assembly 135 of FIG. 1. Similar to the mirror assembly 135 embodiments, the assembly 115 of the instrument panel 145 embodiments also includes a housing 120, a display 124, and a corrective lens 126.

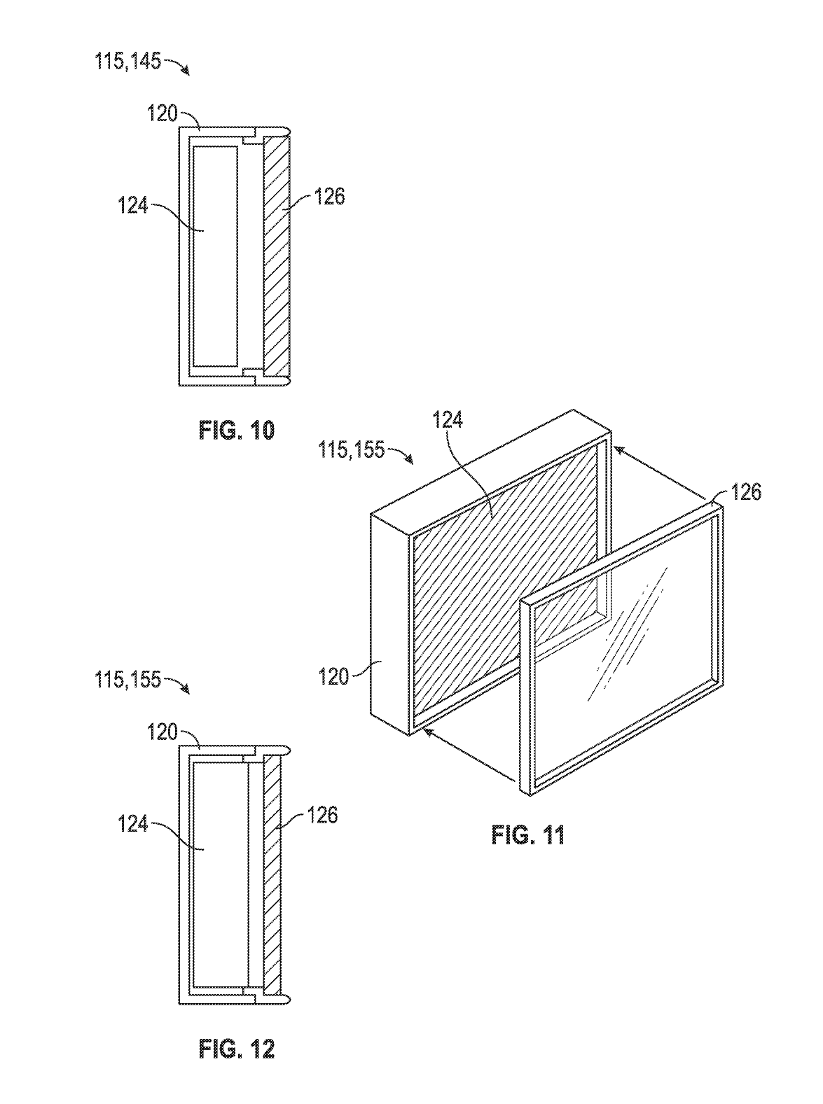

FIGS. 9 and 10 depict, in greater detail, one such exemplary embodiment in which the assembly 115 comprises an instrument panel 145 for the vehicle 100. The housing 120 is preferably formed integral with the vehicle body 102 of FIG. 1, for example as part of a dash board and/or headliner of the vehicle 100. The display 124 is disposed within the housing 120. In one embodiment, the display 124 comprises a gauge for the instrument panel 145. The display 124 provides information for display for the driver and/or one or more occupants of the vehicle (such as, by way of example, a compass heading and/or a temperature inside or outside the vehicle 100). In one such embodiment, the display 124 comprises a video screen. The corrective lens 126 is removable from the housing 120. When the corrective lens 126 is attached to the housing 120, the corrective lens 126 covers the display 124 (and is disposed between the display 124 and the front seat 109), to thereby modify the focal length of the image from the display 124 for viewing by the driver. When the corrective lens 126 is removed from the housing 120 (and is no longer disposed between the display 124 and the front seat 109), the focal length of the image is not modified. In one embodiment, the corrective lens 126 snaps into and out of place against the housing 120.

Returning to FIG. 1, and as mentioned above, in another alternate embodiment, the assembly 115 comprises an infotainment unit 155 for the vehicle 100. The infotainment unit 115 may provide movies, video games, and/or other entertainment and/or information for occupants, preferably of the rear seats 110 of the vehicle 100. Similar to the other embodiments discussed above, the assembly 115 of the infotainment unit 115 also includes a housing 120, a display 124, and a corrective lens 126.

FIGS. 11 and 12 depict, in greater detail, one such exemplary embodiment in which the assembly 115 comprises an infotainment unit 155 for the vehicle 100. The housing 120 is preferably formed integral with the vehicle body 102 of FIG. 1 (for example as part of the headliner) or formed integral or attached against a rear portion of the front seats 109. The display 124 is disposed within the housing 120. In one embodiment, the display 124 comprises a video screen for viewing movies, video games, and/or other entertainment and/or information content, and faces the rear seats 110 so that occupants of the rear seats 110 can view the display 124. The corrective lens 126 is removable from the housing 120. When the corrective lens 126 is attached to the housing 120, the corrective lens 126 covers the display 124 (and is disposed between the display 124 and the rear seats 110), to thereby modify the focal length of the image from the display 124 for viewing by the rear passengers. When the corrective lens 126 is removed from the housing 120 (and is no longer disposed between the display 124 and the rear seats 110), the focal length of the image is not modified. In one embodiment, the corrective lens 126 snaps into and out of place against the housing 120.

Accordingly, in any of the above embodiments, the assembly 115 provides for focal length modification of the display 124 via a corrective lens 126 when desired. The corrective lens is easily removable when it is not needed.

It will be appreciated that the devices, assemblies, systems, and vehicles may vary from those depicted in the Figures and described herein. For example, the vehicle 100, the assembly 115, and/or various components thereof may vary from that depicted in FIGS. 1-12 and described in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. An assembly for a vehicle having an occupant seat, the assembly comprising:
a display; and
a corrective lens disposed between the display and the occupant seat.

2. The assembly of claim 1, wherein the corrective lens comprises a convex lens.

3. The assembly of claim 1, wherein the corrective lens is movable between:
a first position in which the corrective lens covers the display; and
a second position in which the corrective lens does not cover the display.

4. The assembly of claim 3, wherein the corrective lens is slidable between the first position and the second position.

5. The assembly of claim 3, wherein the corrective lens is rotatable between the first position and the second position.

6. The assembly of claim 3, wherein:
the occupant seat comprises a front seat of the vehicle;
the assembly further comprises a rear view mirror;
the display comprises a video screen that is coupled to a back-up camera for the vehicle; and
the rear view mirror and the corrective lens are disposed between the video screen and the front seat.

7. The assembly of claim 6, further comprising:
a housing;
wherein:
the rear view mirror is disposed within the housing between the video screen and the occupant seat;
the corrective lens is disposed in the housing between the video screen and the rear view mirror when in the first position; and
the corrective lens is outside the housing when in the second position.

8. The assembly of claim 6, further comprising:
a housing;
wherein:
the rear view mirror is disposed within the housing between the video screen and the occupant seat; and
the corrective lens is connected to the housing and is disposed between the rear view mirror and the occupant seat when in the first position.

9. A rear view mirror assembly for a vehicle having a front seat, the rear view mirror assembly comprising:
a housing;
a video screen disposed within the housing and coupled to a back-up camera for the vehicle;
a mirror disposed within the housing between the video screen and the front seat;
and a corrective lens disposed between the video screen and the front seat, the corrective lens movable between:
a first position in which the corrective lens covers the video screen; and
a second position in which the corrective lens does not cover the video screen.

10. The rear view mirror assembly of claim 9, wherein the corrective lens comprises a convex lens.

11. The rear view mirror assembly of claim 9, wherein the corrective lens is slidable between the first position and the second position.

12. The rear view mirror assembly of claim 9, wherein the corrective lens is rotatable between the first position and the second position.

13. The rear view mirror assembly of claim 9, wherein the corrective lens is disposed:
in the housing between the video screen and the mirror when in the first position; and outside the housing when in the second position.

14. The rear view mirror assembly of claim 9, wherein the corrective lens is connected to the housing and is disposed between the mirror and the front seat when in the first position.

15. A vehicle comprising:
a body forming an interior of the vehicle;
an occupant seat within the interior; and
an assembly comprising:
a display; and
a corrective lens disposed between the display and the occupant seat.

16. The vehicle of claim 15, wherein the corrective lens comprises a convex lens.

17. The vehicle of claim 15, wherein the corrective lens is movable between:
a first position in which the corrective lens covers the display; and
a second position in which the corrective lens does not cover the display.

18. The vehicle of claim 15, wherein:
the occupant seat comprises a front seat of the vehicle;
the assembly further comprises a rear view mirror;
the display comprises a video screen that is coupled to a back-up camera for the vehicle; and
the rear view mirror and the corrective lens are disposed between the video screen and the front seat.

19. The vehicle of claim 15, wherein the vehicle includes an instrument panel, and the display comprises a gauge for the instrument panel.

20. The vehicle of claim 15, wherein the vehicle includes a rear infotainment unit, and the display comprises a video screen for the rear infotainment unit.
